(19) United States
(12) Patent Application Publication
(10) Pub. No.: US 2018/0345292 A1
(43) Pub. Date: Dec. 6, 2018

(54) FOOD WASTE DISPOSER

(71) Applicant: DONGGUAN JIEMEI ELECTRICAL APPLIANCE CO., LTD., Dongguan, Guangdong (CN)

(72) Inventor: Xiaofeng Liang, Dongguan, Guangdong (CN)

(21) Appl. No.: 15/776,768

(22) PCT Filed: May 18, 2017
(86) PCT No.: PCT/CN2017/084800

§ 371 Date: May 16, 2018

(30) Foreign Application Priority Data
Jun. 23, 2016 (CN) 201610474705.6

(51) Int. Cl. B02C 18/18; B02C 18/00; E03C 1/266

(52) U.S. Cl. CPC B02C 18/18; B02C 2018/188; E03C 1/2665; B02C 18/0092

(57) ABSTRACT

A food waste disposer, including a fixed cutter wall (40) and a rotating cutter head (30) located below the fixed cutter wall (40), the rotating cutter head (30) includes a body portion (32) and a plurality of working teeth (33) extending outwardly from a periphery of the body portion (32); each of the working teeth (33) are provided with cutting surfaces (330) on both opposite side portions thereof, and each of the cutting surfaces (330) is obliquely disposed relative to a top surface and a bottom surface of the working tooth (33) where the cutting surface is located; the fixed cutter wall (40) includes a circular side portion (42) and a plurality of fixed teeth (41) extending outwardly from an end of the circular side portion (42) adjacent to the rotating cutter head (30); the fixed teeth (41) are engaged with the working teeth (33) of the rotating cutter head (30) to perform cutting; each of the fixed tooth (41) are provided with cutting surfaces (410) on both side portions thereof, and each of the cutting surfaces (410) of the fixed teeth (41) is inclined disposed relative to a top surface and a bottom surface of the fixed tooth (41) where the cutting surface is located.

### TECHNICAL FIELD

The present disclosure relates to kitchen appliances, particularly relates to a food waste disposer with a good shearing effect for domestic waste.

### BACKGROUND

Domestic waste, which is a main source of household waste, is mainly derived from the daily diet that inevitably produces some food waste and leftovers. A food waste disposer can effectively dispose the household waste that can easily rot and breed bacteria.

Generally, a conventional disposer breaks the waste and discharges it from sewage pipes, so as to avoid the collection, transportation, and disposal of the waste. However, some hard bone chunks and fibers are still not completely crushed. In particular, the conventional food waste disposer has a poor disposal effect on fiber waste, and the crushed fiber waste has a length greater than l0nm, which can easily cause clogging.

### SUMMARY

Accordingly, the present disclosure provides a reliably connected food waste disposer with high security.

To achieve the object of present disclosure, a technical solution is provided:

A food waste disposer, including a fixed cutter wall and a rotating cutter head located below the fixed cutter wall, wherein the cutter head includes a body portion and a plurality of working teeth extending outwardly from a periphery of the body portion; each of the working teeth are provided with cutting surfaces on both opposite side portions thereof, each of the cutting surfaces is inclined relative to a top surface and a bottom surface of the working tooth where the cutting surface is located; the fixed cutter wall includes a circular side portion and a plurality of fixed teeth extending outwardly from an end of the circular side portion adjacent to the rotating cutter head; the fixed teeth are engaged with the working teeth of the rotating cutter head to perform cutting; each of the fixed teeth are provided with cutting surfaces on both opposite side portions thereof, each of the cutting surfaces of the fixed teeth is inclined relative to a top surface and a bottom surface of the fixed tooth where the cutting surface is located.

In one of the embodiments, an angle formed by a cutting surface of the rotating cutter head and the top surface of the working tooth ranges from 15 degree to 75 degree; and an angle formed by a cutting surface of the fixed cutter wall and the bottom surface of the fixed tooth ranges from 15 degree to 75 degree.

In one of the embodiments, the fixed teeth are spacedly arranged around the circular side portion, and each of the fixed teeth is perpendicular to the circular side portion.

In one of the embodiments, the food waste disposer further includes a grinding chamber configured to receive the rotating cutter head and the fixed cutter wall. The grinding chamber is provided with an anti-splash device, the anti-splash device includes a base, a guard bar, and a folding-back portion connecting the base and the guard bar, and the folding-back portion protrudes inwardly.

In one of the embodiments, the food waste disposer further includes a lower chamber, an upper chamber, and a silicone shockproof sleeve connecting the upper chamber and the lower chamber, the silicone shockproof sleeve includes a side portion and a damping portion extending inwardly from a middle portion of an inner wall of the side portion; and the damping portion defines a receiving groove on a top portion thereof to receive a bottom end of the upper chamber.

In one of the embodiments, the food waste disposer further includes a bottom plate mounted at a portion of the food waste disposer and a PCBA module, the PCBA module comprises a PCBA plate and a protective shield, the protective shield includes a top plate and a side wall extending downwardly from a periphery of the top plate, and the PCBA plate is fixed on a bottom surface of the top plate of the protective shield.

In one of the embodiments, the protective shield further includes a plurality of fixed brackets extending downwardly from a periphery of a bottom of the side wall, the fixed brackets are fixed to the bottom plate, and a height of each of the fixing brackets is less than a height of a bottom of the side wall, so as to separate a bottom portion of the PCBA plate from a top surface of the bottom plate when the PCBA module is mounted on the bottom plate.

In one of the embodiments, the food waste disposer further includes a bottom plate mounted at a bottom of the food waste disposer and a protective sleeve mounted on the bottom plate. The protective sleeve includes a circular body portion and a buffering portion connecting to a bottom end of the body portion. The buffering portion protrudes downwardly and is configured as arch bridge shaped, and the buffering portion extends beyond a bottom surface of the bottom plate, so as to buffer an impact force of when the food waste disposer is fallen.

In one of the embodiments, the body portion is provided with a receiving chamber and a plurality of circumferentially spaced drainage grooves, and the drainage grooves are in communication with the receiving chamber.

In one of the embodiments, the food waste disposer further includes a latching connector configured to connect a drainage pipe. The latching connector includes a latching holder mounted on an outlet pipe of the food waste disposer, an adapter abutting on the latching holder, a pressing plate latched with an end of the adapter, and a circlip snapping with another end of the adapter. The pressing plate is sleeved on the adapter, the adapter is tightly connected to the latching holder via a side end of the pressing plate being embedded into the latching holder and another side end being fixed by a fixing member.

In the rotating cutter head according to present disclosure, the shearing effect is improved by providing cutting surfaces on the surfaces of the working teeth on the rotation cutter head facing away from the fixed cutter wall, thereby reducing the clogging caused by crushed fibers and the efficiency of the food waste disposer is improved.

### BRIEF DESCRIPTION OF THE DRAWINGS

FIG. 1 is a perspective view of a food waste disposer according to present disclosure connected to a drainage pipe;

FIG. 2 is a partial assembled view of the food waste disposer of FIG. 1 with the housing removed;

FIG. 3 is an exploded view of the food waste disposer of FIG. 2;

FIG. 4 is a partial cross-sectional view of the food waste disposer of FIG. 3 after a lower portion assembled with an upper chamber lid;

FIG. 5 is a schematic view of assembled rotating cutter head and fixed cutter wall of the food waste disposer of FIG. 1;

FIG. 6 is a exploded view of the rotating cutter head and fixed cutter wall of FIG. 5;

FIG. 7 is a schematic view of the reversed rotating cutter head of FIG. 5;

FIG. 8 is an enlarged view of circle A of FIG. 6;

FIG. 9 is a schematic view of an anti-splash device of a grinding chamber of FIG. 3;

FIG. 10 is a schematic view of a silicone shockproof sleeve of FIG. 3;

FIG. 11 is a partial cross-sectional view of the silicone shockproof sleeve of FIG. 10;

FIG. 12 is a schematic view of a bottom of the food waste disposer of FIG. 1 with the housing removed;

FIG. 13 is a exploded view of a PCBA module of the food waste disposer of FIG. 12;

FIG. 14 is a schematic view of the reversed PCBA module of FIG. 13;

FIG. 15 is a schematic view of a protective sleeve of FIG. 4; and

FIG. 16 is an exploded view of the food waste disposer and the drainage pipe of FIG. 1.

### DETAILED DESCRIPTION OF THE EMBODIMENTS

Embodiments of the present disclosure are described more fully hereinafter with reference to the accompanying drawings. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art.

Unless otherwise defined, all terms (including technical and scientific terms) used herein have the same meaning as commonly understood by one of ordinary skill in the art to which this invention belongs. The terms used herein is for the purpose of describing particular embodiments only and is not intended to limit the present disclosure.

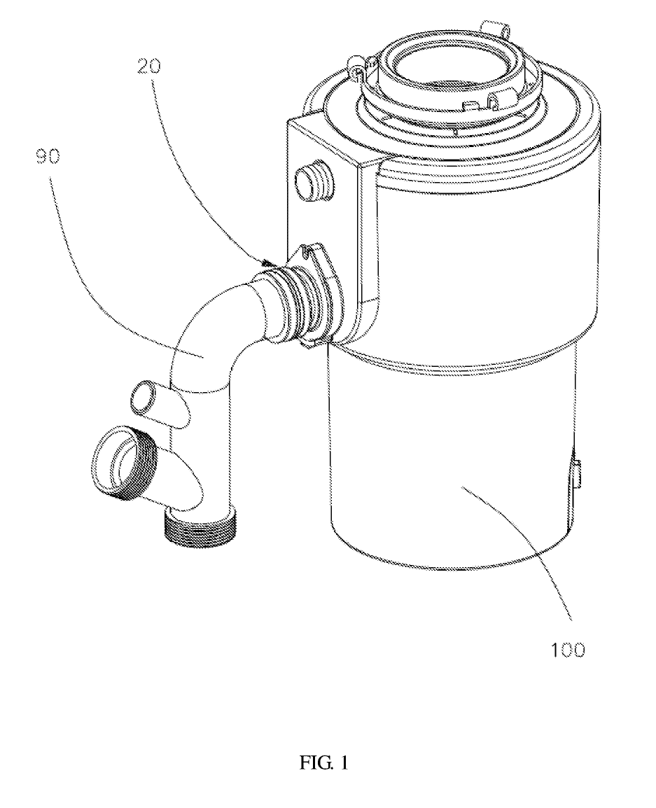

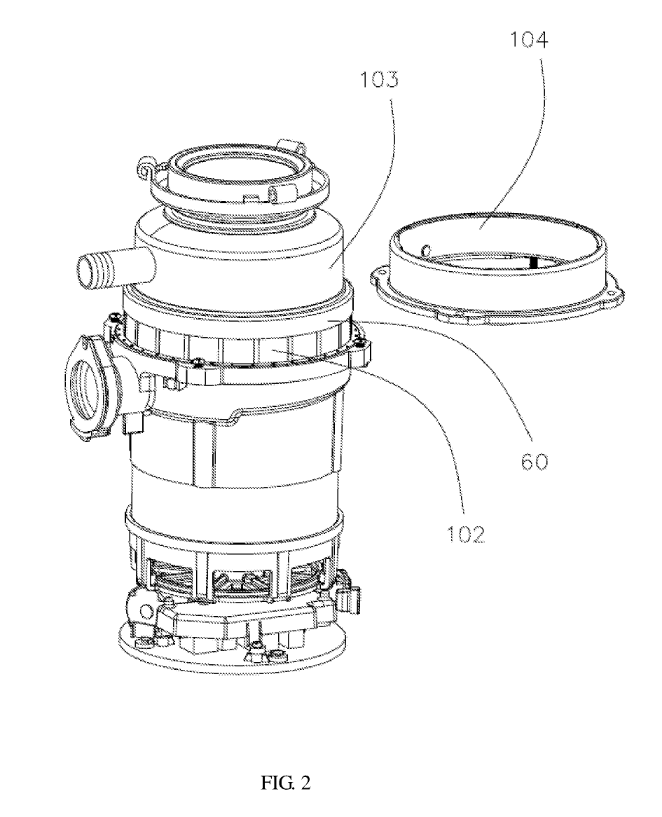

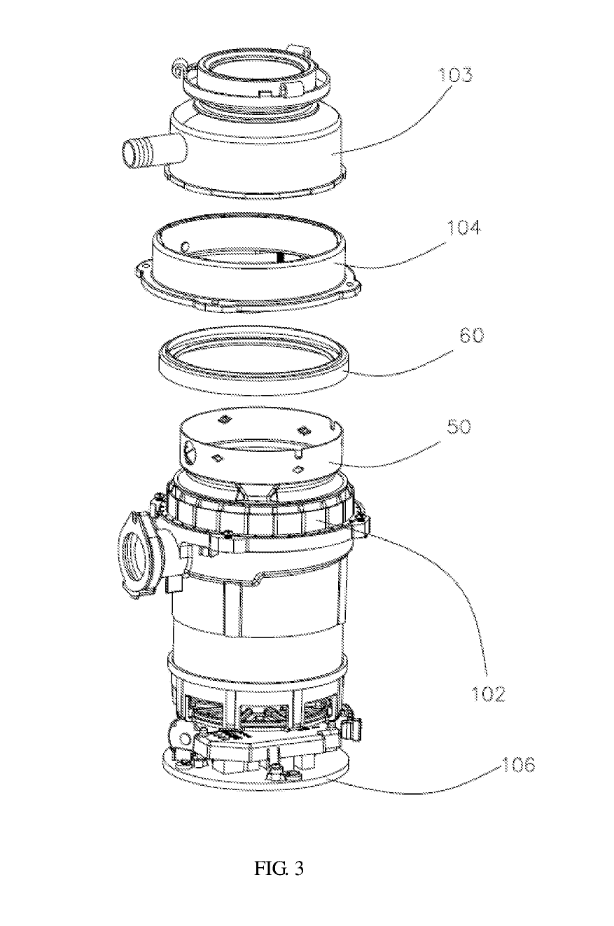

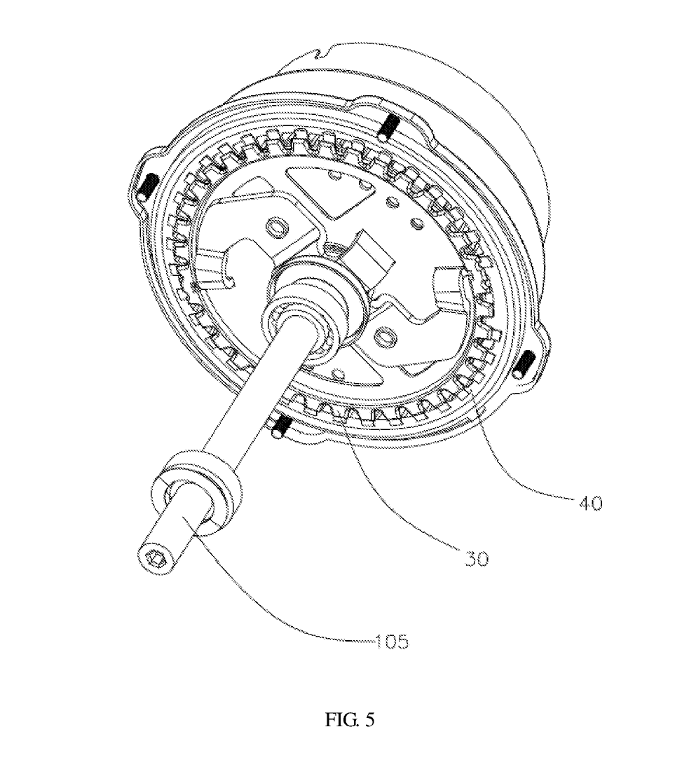

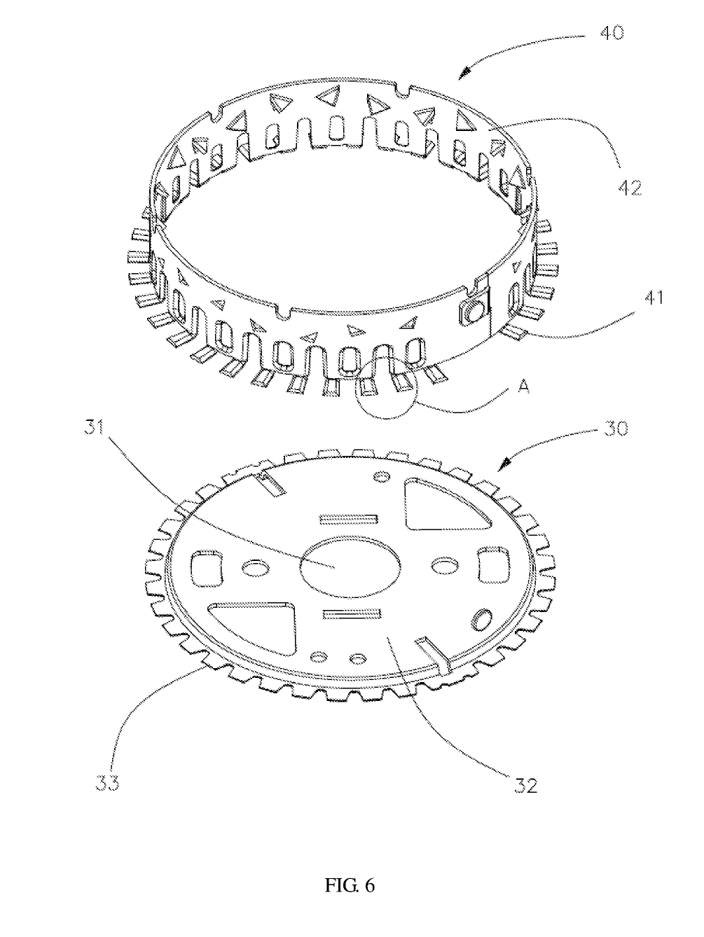

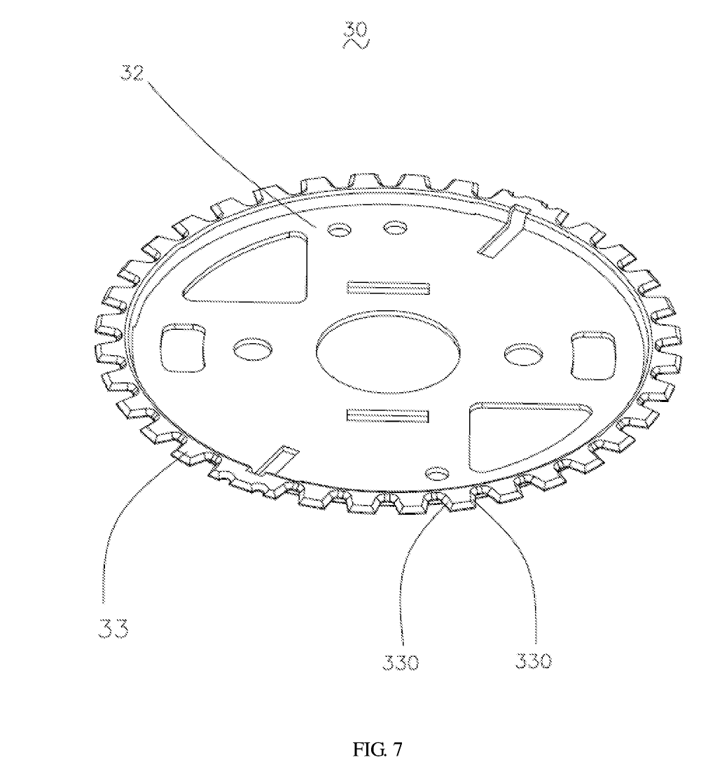

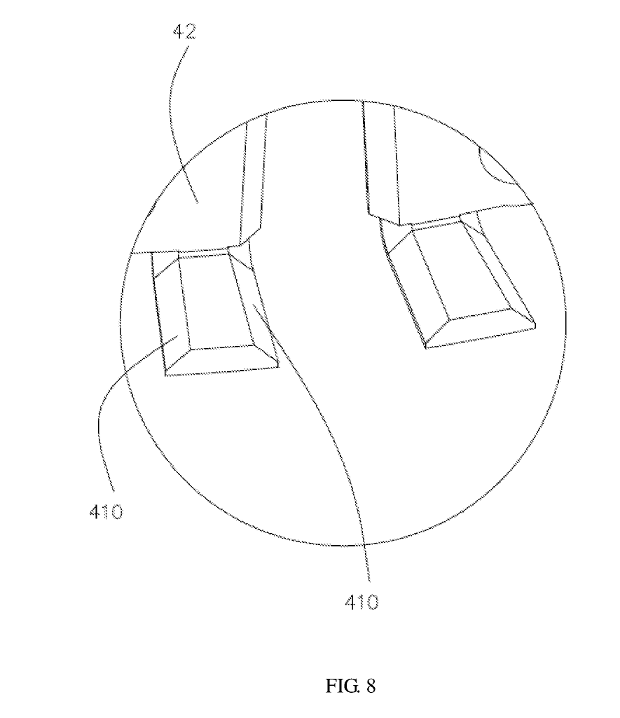

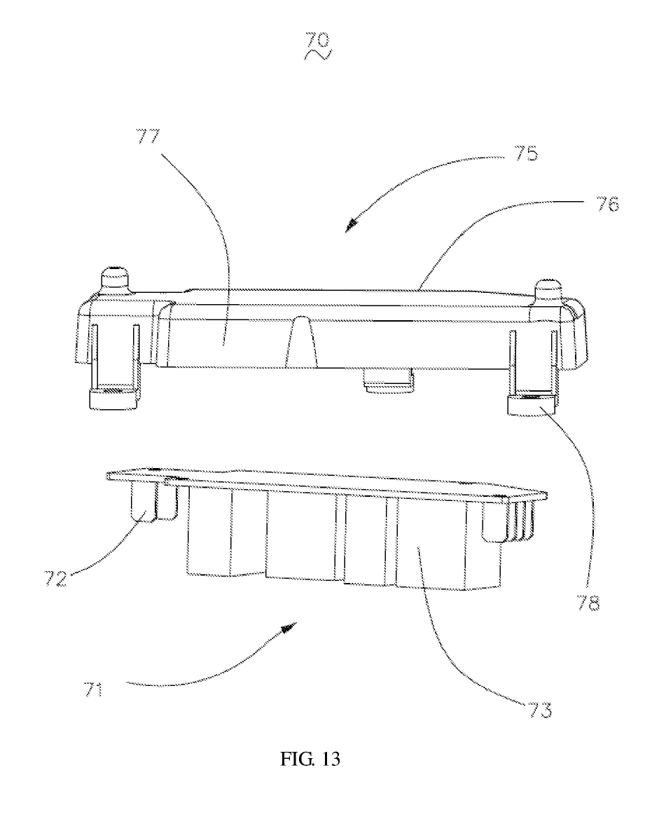

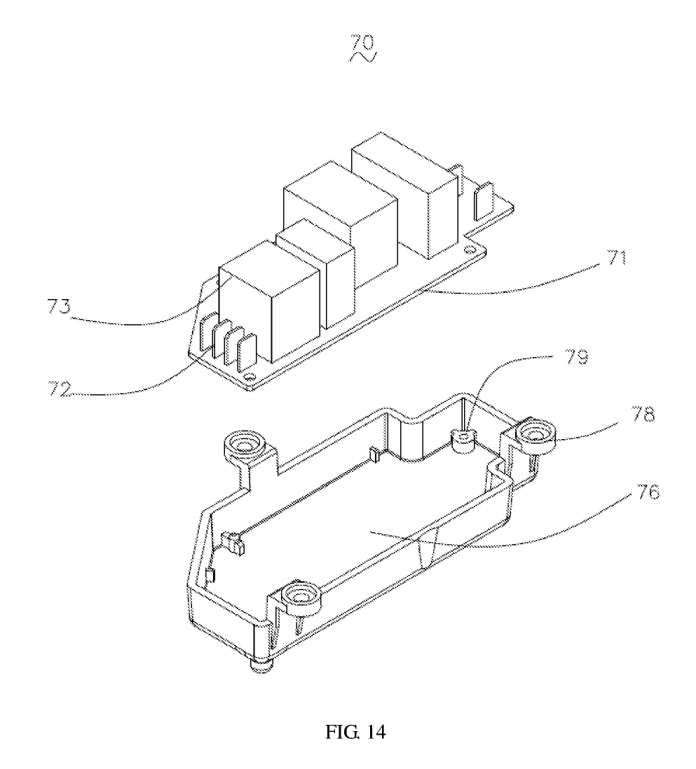

Referring to FIG. 1 to FIG. 16, a food waste disposer 100 according to a preferred embodiment of present disclosure is provided to dispose the food waste of kitchen. The food waste disposer 100 includes a latching connector 20 configured to connect a drainage pipe 101, a housing, a lower chamber 102, an upper chamber 103, an upper chamber lid 104 connecting the upper chamber 103 and the lower chamber 102, a silicone shockproof sleeve 60 clamped between the lower chamber 102 and the upper chamber 103, a grinding chamber 50 connecting to the upper chamber 103, a rotating cutter head 30 and fixed cutter wall 40 mounted in the grinding chamber 50, and a PCBA module 70 mounted on a bottom of the housing. The rotating cutter head 30 is connected to a motor via a spindle. The housing includes a bottom plate 109, and the PCBA module 70 is mounted upside down on the bottom plate 109.

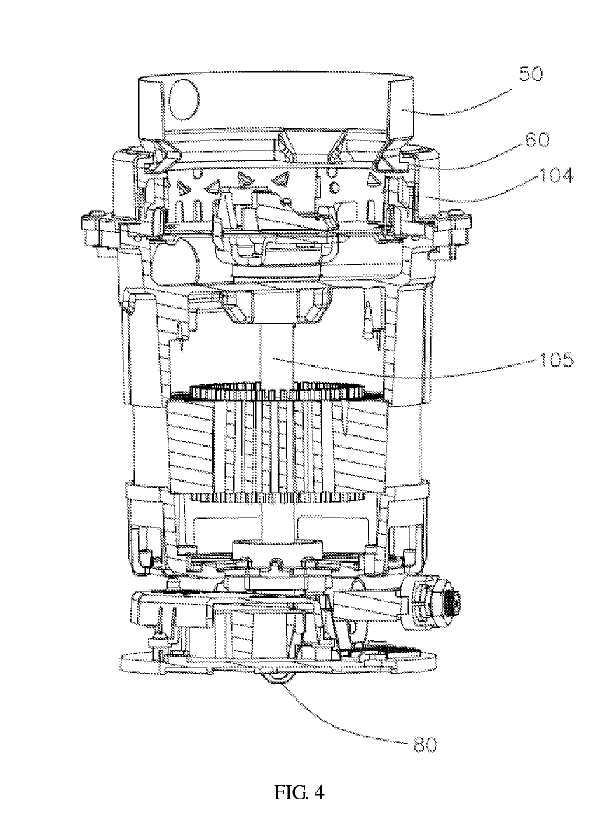

Referring to FIG. 4 to FIG. 8, the rotating cutter head 30 includes a discoid body portion 32 and a plurality of working teeth 33 extending outwardly from a periphery of the body portion 32; a center hole 31 is defined on the body portion 32 in order to engage with the assemble of a maim axis.

A top surface of the working tooth 33 of the rotating cutter head 30, i.e. the surface facing the fixed cutter wall 40, is configured as a flat surface; a bottom surface of the working tooth 33, i.e. the surface facing away from the fixed cutter wall 40, is configured as a flat surface. Each of the working teeth 33 are provided with cutting surfaces 330 on both opposite portions thereof, each of the cutting surfaces 330 is inclined relative to a top surface and a bottom surface of the fixed tooth where the cutting surface is located. In the illustrated embodiment, the two cutting surfaces 330 of the same working tooth 33 are inclined opposite, so as to improve the cutting force of the rotating cutter head 30. Specifically, each of the working teeth 33 is configured as a reversed trapezoidal shape as viewed in cross-section. The cutting surface 330 and the top surface of the working teeth 33 forms an acute angle. Specifically, an angle formed by the cutting surface 330 and the top surface of the working tooth 33 ranges from 15 degree to 75 degree. In alternative embodiments, an angle formed by the cutting surface 330 and the top surface of the working teeth 33 ranges from 30 degree to 60 degree.

The fixed cutter wall 40 of the food waste disposer includes an upright circular side portion 42 and a plurality of fixed teeth 41 extending outwardly from an end of the circular side portion 42 adjacent to the rotating cutter head 30, the fixed teeth 41 are engaged with the working teeth 33 to perform cutting.

The fixed teeth 41 include bottom surfaces 30 facing the rotating cutter head 30 and bottom surfaces facing away from the rotating cutter head 30. Two side portions of each of the fixed teeth 41 are provided with cutting surfaces 410, each of the cutting surfaces is inclined relative to a top surface and a bottom surface of the fixed tooth 410, the two cutting surfaces 410 of same fixed tooth 41 are inclined opposite. Each of the fixed teeth 41 is configured as a trapezoidal shape as view in cross-section or from the outside. The cutting surface 410 and the bottom of the fixed tooth 41 form an acute angle, specifically, an angle formed by the cutting surface 410 and the bottom of the fixed tooth 41 ranges from 15 degree to 75 degree. In alternative embodiments, an angle formed by the cutting surface 410 and the bottom of the fixed tooth 41 ranges from 30 degree to 60 degree.

The rotating cutter head 30 and the fixed cutter wall 40 according to present utility module are formed via integrally stamping and bending metal parts.

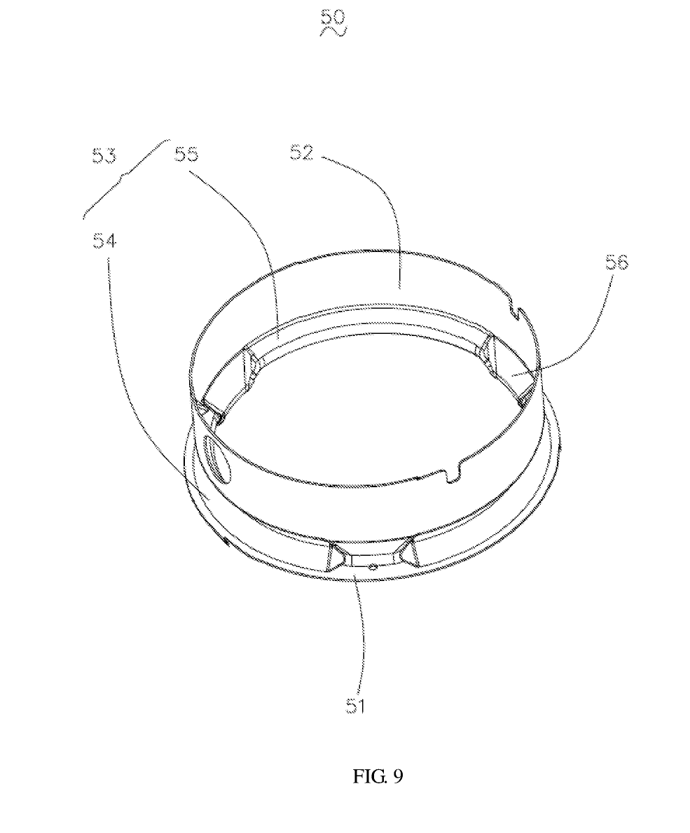

Referring to FIG. 9, the grinding chamber 50 is provided with an anti-splash device, which includes a base 51, a guard bar 52, and a folding-back portion 53 connecting the base and the guard bar 52. The folding back portion 52 is configured to fold back the food waste hit upward by the rotating cutter head 30 and the fixed cutter wall 40, and to lead the food waste into the food waste disposer to be crushed again. In the illustrated embodiment, the base 51, the guard bar 52, and the folding-back portion 53 are integrally formed by metal sheet. The folding-back portion 53 includes a first connecting portion 54 connecting to the base 51, and a second connecting portion 55 connecting to the guard bar 52. The first connecting portion 54 is inclined and extending inwardly and downwardly from the guard bar 53; and the second connecting portion 55 is connected to the first connecting portion 54, and the second connecting portion 55 protrudes inwardly.

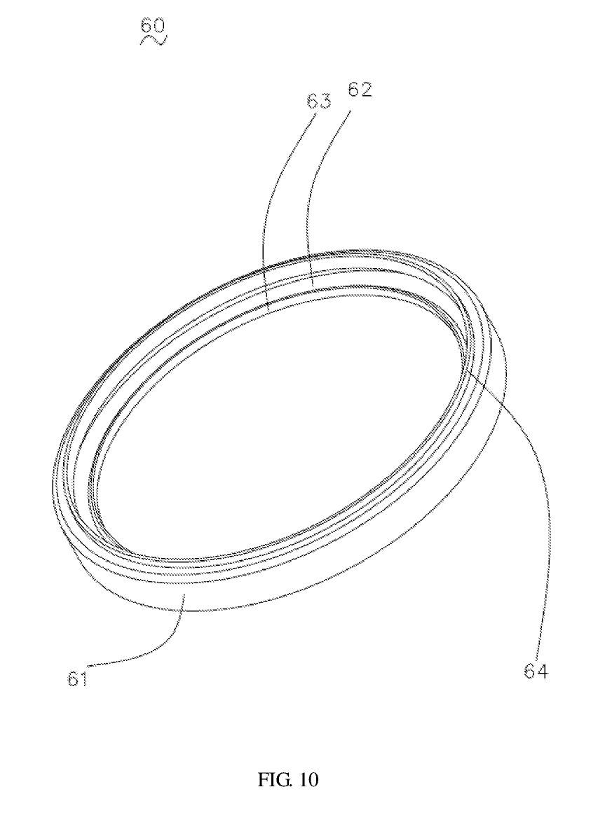

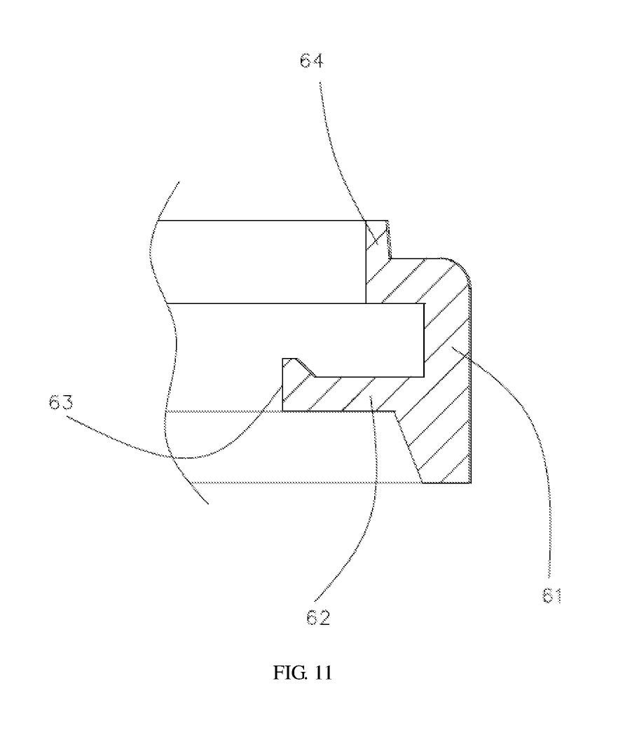

Referring to FIG. 10 and FIG. 11, the silicone shockproof sleeve 60 connects the upper chamber 102 and the lower chamber 103. The silicone shockproof sleeve 60 includes a side portion 61 and a damping portion 62 extending inwardly from a middle portion of an inner wall of the side portion 61. The damping portion 62 is provided with a protruding edge 63 extending upwards, thus the damping portion 62 defines a receiving groove on the top portion thereof, and a top of the side portion 61 is provided with a convex portion 64 extending upwards. The receiving groove of the damping portion 62 is configured to receive a bottom end of the upper chamber 103, and an inner wall of the convex portion 64 is configured to abut an outer wall of the bottom end of the upper chamber 103. A bottom surface of the damping portion 62 and the inner wall of the bottom portion of the side portion 61 are cooperatively received in the lower chamber 102.

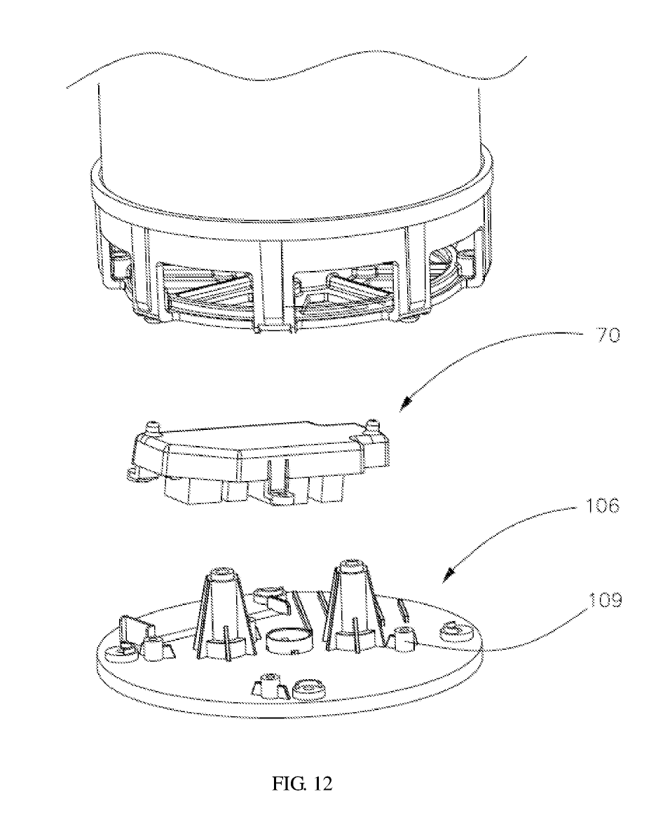

Referring to FIG. 12 to FIG. 14, the PCBA module 70 includes a PCBA plate 71 and a protective shield 75. The PCBA plate 71 is fixed upside down on a bottom of the protective shield 75, the protective shield 75 is fixed on the bottom plate 109, therefore the protective shield 75 covers the top and surrounding parts to prevent the small amount of water drops from entering the PCBA plate 71.

The PCBA plate 71 includes a plurality of metal terminals 72 and electronic element 73. The protective shield 75 is an insulating housing, specifically a plastic housing. The protective shield 75 is not provided with through holes, so as to ensure its waterproof performance. The protective shield 75 includes a top plate 76 and a side wall 77 extending downwardly from a periphery of the top plate 76, and the top plate 76 and the side wall 77 cooperatively form a receiving chamber to receive a part of the PCBA plate 71. In the illustrated embodiment, the shape of the top plate 76 corresponds to the shape of the PCBA plate 71. A bottom surface of the top plate 76 extends downwardly to reach a plurality of mounting posts 79, so as to fix the PCBA plate 71. The protective shield further includes a plurality of fixed brackets 78 extending downwardly from a periphery of a bottom of the side wall 77, the fixed brackets 78 are configured to fix to the bottom plate 109. A height of each of the fixing brackets 78 is less than a height of a bottom of the side wall 77, so as to separate a bottom portion of the PCBA plate 71 from a top surface of the bottom plate 109 when the PCBA module 70 is mounted on the bottom plate 109, to ensure the waterproof effect of the protective shield 75 and the heat dissipation effect of the PCBA plate 71.

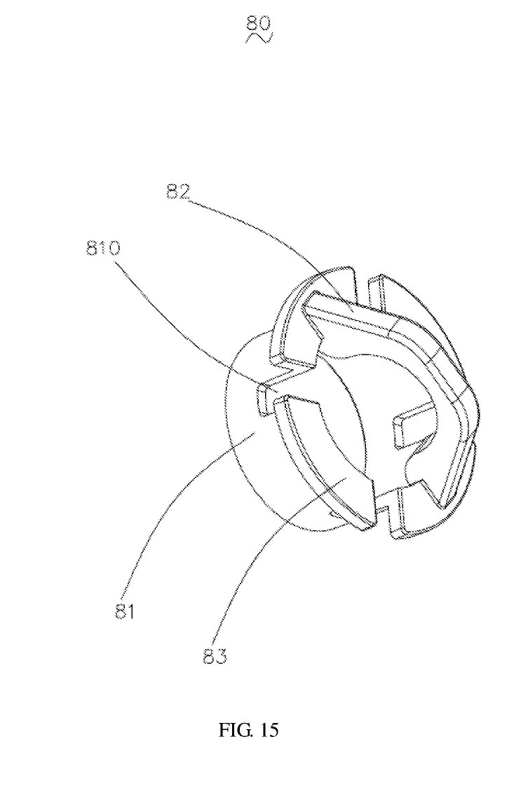

Referring to FIG. 15, the food waste disposer 100 further includes a protective sleeve 80 mounted on the bottom plate 109, and the protective sleeve 80 extends through the bottom plate 109 and sleeves on an axis of motor 105. The protective sleeve 109 includes a circular body portion 81 and a buffering portion 82 connected to a bottom end of the body portion 81. The body portion 81 is provided with a receiving chamber to receive the axis of motor 105. The buffering portion 82 protrudes downwardly and is configured as arch bridge shaped, and the buffering portion 82 extends beyond a bottom surface of the bottom plate 109, so as to buffer an impact force of when the food waste disposer falls. The body portion 81 has a cylinder shape, and a bottom of the body portion 81 extends outwardly to form a protruding edge 83. A part of the body portion 81 adjacent to the buffering portion 82 is provided with a plurality of circumferentially spaced drainage grooves 810, and the drainage grooves 810 is in communication with the receiving chamber of the body portion 81.

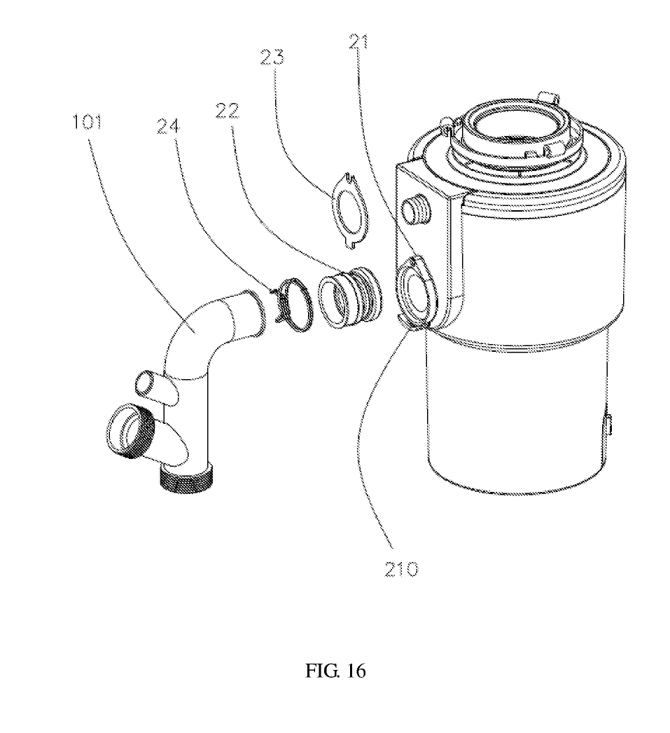

Referring to FIG. 16, the latching connector 20 includes a latching holder 21 mounted on an outlet pipe of the food waste disposer, an adapter 22 abutting the latching holder 21, a pressing plate 23 latched with an end of the adapter 22, and a circlip 24 snapping with another end of the adapter 22. The pressing plate 23 is sleeved on the adapter 22. The adapter 22 is tightly connected to the latching holder 21 via a side end of the pressing plate 23 being imbedded into the latching holder 21 and another side end being fixed by a fixing member, and the downstream drainage pipe is locked via the circlip 24, so as to achieve a quick connection between the food waste disposer and the downstream drainage pipe 105. One end of the latching holder 21 is provided with a slot 210, and the other end opposite to the slot 210 is provided with a threaded hole. The adapter 22 is an elastic soft connector made of a soft material, such as a rubber material. The pressing plate 23 has a circular shape, and a center hole is provided in the middle part. One end of the pressing plate 23 is provided with a mounting port for screw locking, and the other end extends outwardly to form a latching block. The circlip 24 is formed via integrally bending a metal material.

In the food waste disposer according to present disclosure, the shearing effect is improved by providing cutting surfaces on the rotating cutter head and the fixed cutter wall. Particularly to the fiber waste, the cut fiber waste has a length of 4 mm or less, thus the clogging caused by crushed fibers is prevented and the efficiency of the food waste disposer is improved. The upside down configured PCBA module, the anti-splash device of the grinding chamber, the silicone shockproof sleeve, and the protective sleeve and the like effectively improve the performance of various aspects of the food waste disposer.

The previously described implementations are merely specific embodiments of the present disclosure, and are not intended to limit the protection scope of the present disclosure. It should be noted that any variation or replacement readily figured out by persons skilled in the art within the technical scope disclosed in the present disclosure shall all fall within the protection scope of the present disclosure. Therefore, the protection scope of the present disclosure shall be subject to the protection scope of the claims.

What is claimed is:

1. A food waste disposer, comprising:
a fixed cutter wall; and
a rotating cutter head located below the fixed cutter wall, wherein the rotating cutter head comprises a body portion and a plurality of working teeth extending outwardly from a periphery of the body portion; each of the working teeth are provided with cutting surfaces on both opposite side portions thereof, each of the cutting surfaces is inclined relative to a top surface and a bottom surface of the working tooth where the cutting surface is located; the fixed cutter wall comprises a circular side portion and a plurality of fixed teeth extending outwardly from an end of the circular side portion adjacent to the rotating cutter head; the fixed teeth are engaged with the working teeth of the rotating cutter head to perform cutting; each of the fixed teeth are provided with cutting surfaces on both opposite side portions thereof, and each of the cutting surfaces of the fixed teeth is inclined relative to a top surface and a bottom surface of the fixed tooth where the cutting surface is located.

2. The food waste disposer according to claim 1, wherein an angle formed by a cutting surface of the rotating cutter head and the top surface of the working tooth ranges from 15 degree to 75 degree; and an angle formed by a cutting surface of the fixed cutter wall and the bottom surface of the fixed tooth ranges from 15 degree to 75 degree.

3. The food waste disposer according to claim 1, wherein the fixed teeth are spacedly arranged around the circular side portion, and each of the fixed teeth is perpendicular to the circular side portion.

4. The food waste disposer according to claim 1, further comprising a grinding chamber configured to receive the rotating cutter head and the fixed cutter wall, wherein the grinding chamber is provided with an anti-splash device, the anti-splash device comprises a base, a guard bar, and a folding-back portion connecting the base and the guard bar, and the folding-back portion protrudes inwardly.

5. The food waste disposer according to claim 1, further comprising a lower chamber, an upper chamber, and a silicone shockproof sleeve connecting the upper chamber and the lower chamber, the silicone shockproof sleeve comprises a side portion and a damping portion extending inwardly from a middle portion of an inner wall of the side portion; and the damping portion defines a receiving groove on a top portion thereof to receive a bottom end of the upper chamber.

6. The food waste disposer according to claim 1, further comprising a bottom plate mounted at a bottom of the food waste disposer and a PCBA module, wherein the PCBA module comprises a PCBA plate and a protective shield, the protective shield comprises a top plate and a side wall extending downwardly from a periphery of the top plate, and the PCBA plate is fixed on a bottom surface of the top plate of the protective shield.

7. The food waste disposer according to claim 6, wherein the protective shield further comprises a plurality of fixed brackets extending downwardly from a periphery of a bottom of the side wall, the fixed brackets are fixed to the bottom plate, and a height of each of the fixing brackets is less than a height of a bottom of the side wall, so as to separate a bottom portion of the PCBA plate from a top surface of the bottom plate when the PCBA module is mounted on the bottom plate.

8. The food waste disposer according to claim 1, further comprising a bottom plate mounted at a bottom of the food waste disposer and a protective sleeve mounted on the bottom plate, wherein the protective sleeve comprises a circular body portion and a buffering portion connecting to a bottom end of the body portion; the buffering portion protrudes downwardly and has an arch bridge shape, and the buffering portion extends beyond a bottom surface of the bottom plate, so as to buffer an impact force of when the food waste disposer is fallen.

9. The food waste disposer according to claim 8, wherein the body portion defines a receiving chamber and a plurality of circumferentially spaced drainage grooves, and the drainage grooves are in communication with the receiving chamber.

10. The food waste disposer according to claim 1, further comprising a latching connector configured to connect a drainage pipe, wherein the latching connector comprises a latching holder mounted on an outlet pipe of the food waste disposer, an adapter abutting on the latching holder, a pressing plate latched with an end of the adapter, and a circlip snapping with another end of the adapter, the pressing plate is sleeved on the adapter, the adapter is tightly connected to the latching holder via a side end of the pressing plate being embedded into the latching holder and another side end being fixed by a fixing member.
